(19) United States
(12) Patent Application Publication
(10) Pub. No.: US 2009/0273156 A1
(43) Pub. Date: Nov. 5, 2009

(54) PLANETARY GEAR TRANSMISSION AND VEHICLE USING SAME

(76) Inventor: Donghwan Byun, Seoul (KR)

Correspondence Address: IPLA P.A., 3580 WILSHIRE BLVD., 17TH FLOOR, LOS ANGELES, CA, 90010, US

(21) Appl. No.: 12/447,236

(22) PCT Filed: Oct. 24, 2007
(86) PCT No.: PCT/KR07/05239

§ 371 Date: Apr. 24, 2009

(30) Foreign Application Priority Data
Oct. 24, 2006 (KR) 10-2006-0103724

(51) Int. Cl. F16H 3/44; A61G 5/02; A61G 5/10

(52) U.S. Cl. 280/250.1; 475/269

(57) ABSTRACT

This invention touches the planetary gear type transmission which is comprised of a pair of single planetary gear rows are combined, and a carrier of one side and a ring gear of the other side are integrated, and a housing of a transmission is formed with the help of two carriers which operate as an input side and an output side, respectively. The transmission work is implemented by controlling the each sun gear which is rotatably installed at the fixed center shaft to engage or disengage with said center shaft or by controlling an integration and a disintegration of two sun gears. This invention gives the planetary gear type transmission a compact size and a light weight because the carrier plays a role for the housing. The center shaft can be engaged and disengaged with the body of the vehicle. One can choose any mode in an acceleration mode, a deceleration mode and a direct connection mode, without using the clutch and under any mode the planetary gear type transmission transmits the driving force in both ways.

### TECHNICAL FIELD

This invention touches the planetary gear type transmission which can be used for an acceleration, a deceleration and a direct connection mode without using the clutch. The planetary gear type transmission has two single planetary gear rows and a carrier of one side and a ring gear of the other side are integrated and a housing of gear transmission is formed with the help of two carriers which operates as an input side and output side, respectively. So the size and the weight of planetary gear type transmission is small and light. The center shaft of planetary gear type transmission is easily engaged and disengaged with the body of the wheel chair.

### BACKGROUND ART

The transmission is generally an unit for changing the rotation speed of axis. The belt, the friction wheel or the gearbox have been used. When we use gearbox, a circumscribing gear transmission using the spur gear, the helical gear and the gear train and the planetary gear transmission are usually used using an inscribing gear in which one gear is interlinked to the another large gear and using the pinion gear which is interlinked to the outer surface of the sun gear.

The transmission using the gear like the spur gear, helical gear and gear train, however, brings some problems. The shock power between the teeth of two different gear while meshing to change the rotation speed influences to each teeth and the load concentrated on each teeth causes the breakage or the worn-out of the teeth. A noise or a vibration also happens caused by a partly mesh of each gear. It means the mesh between the teeth is not fluent even we considered the number of whole teeth formed along the outer circumferential surface.

The planetary gear type transmission which uses the inscribing gear brings the lower shock power and the smaller load to the teeth than any other type of the gear train when the teeth are meshed. It is now used in the field like an aircraft industry, a car industry, an office machine industry, a machine tool industry which needs the smaller size and volume and the lighter weight because it has a higher efficiency of power transmission, and the more teeth are meshed to make lesser noise and vibration, and the input and the output use the same center.

The wheelchair needs the stronger physical strength of arms to operate the two wheels. The wheel and the circular push rim is fixed and the radius of the push rim is smaller than that of the wheel. The moment to the push rim should be larger than that of the wheel for wheeling the wheelchair, which causes many troubles to the people or makes them give up when they want to climb up even the low slope. Several transmissions have been suggested to lessen the physical power for climbing the slope by changing the rotational ratio between the wheel and the push rim. The specific deceleration ratio wheelchair or multi-stage transmission wheelchair, for example, using the patent like the American U.S. Pat. No. 5,362,081 and the Japanese patent 2000-316914, have been proposed to solve the above problems. These products are sometimes hard to drive under the conditions of the road surfaces or hard to change speed while driving because the speed change and the transmission of driving force can not happen simultaneously. The transmission device itself of these products are heavy and high price due to their complexity and furthermore too noisy. They couldn't satisfy users.

### DISCLOSURE OF INVENTION

### Technical Problem

This invention is designed for solving above problems. The new transmission for the wheelchair will be introduced that has a low cost, light weight and thinner structure as well as easy and quick speed change while driving. The new universal transmission will be proposed that is easy to use for the home appliances.

### Technical Solution

This invention provides the transmission to solve above problems that a pair of single planetary gear rows are combined, and a carrier of one planetary gear and a ring gear of the other planetary gear are integrated, and a housing of a transmission is formed with the help of said two carriers which operate as an input side and an output side, respectively, and transmission work is implemented by controlling the each sun gear which is rotatably installed at the fixed center shaft to engage or disengage with the center shaft or by controling an integration or a disintegration of two sun gears.

One can choose the one of the following 4 modes through this structure during operation; an acceleration mode in which one sun gear of the planetary gear is fixed to the center shaft and does not relatively rotate with respect to the center shaft; a direct connection mode in which two sun gears are integrated and idly rotate with respect to the center shaft; a deceleration mode in which the other sun gear is fixed to the center shaft and does not relatively rotate with respect to the center shaft; a stop mode in which two sun gears are integrated with each other and fixed to the center shaft so that two sun gears do not relatively rotate with respect to the center shaft.

It is desirable that the planetary gear type transmission includes a groove cam rotational member which is immovable in an axial direction and rotatably supported by the center shaft and has two grooves on the outer surface of the same for the groove cam; a first groove cam which moves along the first groove on the groove cam rotational member in an axial direction to the position which makes one of sun gears engage to the center shaft so that the fixed sun gear can not rotate and which at the same time makes the other sun gear idly rotate with respect to the center shaft and the first groove cam moves to the position which allows both sun gears not to engage with each other; the second groove cam which moves along the second groove of the groove cam rotational member in an axial direction and which allows two sun gears engage with each other so that two sun gears rotate freely with respect to the center shaft. The engagement and the disengagement and an integration and disintegration of two sun gears are controlled depending on a rotational position of the groove cam rotational member for the transmission work.

The each said sun gear includes protrusions on the inner circumferential surface of the sun gear and on the mutually facing side surfaces of two sun gears, respectively. The first and the second groove cam are unrotatably supported by the center shaft. The first groove cam has protrusions on the outer circumferential surface of the same to engage with protrusions of the inner circumferential surface of each sun gear and moves to the position to engage one of sun gears or moves to the position not to engage both sun gears. The second groove cam pressurizes one sun gear in an axial direction and makes the sun gear move to the position in which the side surface protrusions of both sun gears are engaged with each other when the first groove cam disengages with both sun gears. The engagement and the disengagement and an integration and disintegration of two sun gears are controlled depending on the rotational position of the groove cam rotational member for the transmission work.

It is also desirable that the groove cam rotational member is controlled by a transmittable shaft which passes through the center shaft in an axial direction.

The transmittable shaft is extended passing through the center shaft and the extended part of the same is engaged with a transmission handle by means of a stripe or a link mechanism or the like. The transmission work is implemented depending on the rotational position of the groove cam rotational member determined by moving the transmission handle.

The transmission handle is engaged with at least two planetary gear type transmissions by means of a stripe or a link mechanism or the like so that the transmission work of all the planetary gear type transmission connected with the transmission handle is implemented simultaneously.

The transmission handle is engaged with an actuator and includes a sensor for detecting a torque transferred from a driving unit, and includes a controller which judges in accordance with the data from the sensor and controls the actuator so that a transmission work is automatically implemented.

The center shaft is quickly engaged and disengaged with a body of vehicle and does not rotate with respect to the body of the vehicle when it is engaged.

The planetary gear type transmission is positioned at the center of the wheels of a vehicle with one carrier being engaged with the driving unit, with the other carrier being engaged with the wheels.

If present invention is applied to the vehicle like a wheelchair, the planetary gear type transmission will be installed as follows.

Two single planetary gear rows are installed in each wheel hub of the wheelchair in which a housing of the transmission is formed with the help of two carriers which operate as an input side and an output side, respectively and a carrier of one side and a ring gear of the other side are integrated. The transmission work is implemented either by allowing each sun gear which is installed at the fixed center shaft to engage or to disengage with the center shaft or by controlling an integration or a disintegration with two sun gears. The planetary gear type transmission is installed at the center of wheels, with one carrier being engaged with the driving unit, with the other carrier being engaged with the wheels.

The wheels including center shaft are quickly engaged and disengaged with wheelchair. The transmission work is controlled by the transmission shaft which passes through the center shaft in an axial direction. The transmission shaft of each wheel passes through the center shaft and the transmission handle is engaged with the protruded part of the transmission shaft by means of a stripe or a link mechanism or the like so that the transmission work of two wheels of wheelchair is implemented concurrently by moving one transmission handle. The driving unit is a push rim of the wheelchair which is driven by the manpower.

### Advantageous Effects

This invention gives the planetary gear type transmission a compact size and a light weight because the carrier plays a role for the housing. The center shaft can be engaged and disengaged with the body of the vehicle. One can choose any mode in an acceleration mode, a deceleration mode and a direct connection mode, without using the clutch and under any mode the planetary gear type transmission transmits the driving force in both ways. Especially in the direct connection mode the push rim and the wheel are connected directly and they rotate at the same speed.

### BRIEF DESCRIPTION OF THE DRAWINGS

FIG. 1 is a perspective view illustrating a device of this invention mounted on the wheelchair
a) side view from the outside
b) side view from the inside

FIG. 2 is an exploded perspective view of parts of 3-speed planetary gear type transmission

FIG. 3 is a regional sectional view illustrating an acceleration mode of 3-speed planetary gear type transmission

FIG. 4 is a sectional view taken along the line A-A of FIG. 3

FIG. 5 is a regional sectional view of a direct connection mode of 3-speed planetary gear type transmission

FIG. 6 is a sectional view taken along the line B-B of FIG. 5

FIG. 7 is a regional sectional view of a deceleration mode of 3-speed planetary gear type transmission

FIG. 8 is a sectional view taken along the line C-C of FIG. 7

FIG. 9 is a perspective view illustrating the center shaft of 3-speed planetary gear type transmission

FIG. 10 is a perspective view illustrating the transmission shaft of 3-speed planetary gear type transmission

FIG. 11 is a perspective view illustrating the groove cam rotational member of 3-speed planetary gear type transmission

FIG. 12 is a perspective view illustrating the transmission key of 3-speed planetary gear type transmission

FIG. 13 is a perspective view illustrating the first groove cam of 3-speed planetary gear type transmission

FIG. 14 is a perspective view illustrating the second groove cam of 3-speed planetary gear type transmission

FIG. 15 is a perspective view illustrating the sun gear of 3-speed planetary gear type transmission

FIG. 16 is a perspective view illustrating the input carrier inscribing gear holder of 3-speed planetary gear type transmission

FIG. 17 is a perspective view illustrating the wheel center shaft of 3-speed planetary gear type transmission

1: Center Shaft 2: Transmission Shaft
3: Groove Cam rotational Member
4: Groove Cam Rotation Direction Fixing member
5 : Transmission Key 6: The First Groove Cam
7: The Second Groove Cam 8: Acceleration Sun Gear
9: Deceleration Sun Gear 10: Acceleration planetary gear
11: Deceleration planetary gear
12: Acceleration inscribing gear
13: Deceleration inscribing gear 14: Input Carrier
15: Input Carrier Inscribing Gear Holder
16: Input Carrier Push Rim Holder
17: Output Carrier (Wheel Center Shaft ) 18: Wheel
19: Acceleration Planetary Gear Shaft
20: Deceleration Planetary Gear Shaft
8z, 9z, 10z, 11z, 14z, 17z: Bearing 21: Key
24: Spring 25: Transmittable Key Engaging Ring
26, 6a, 7a: Ball 27: Wheel Center Shaft Block
28: Center Shaft Fastening Member 29: Disc Hub
30: Stripe Handle for Transmission
31: Stripe for Transmission Fastening Plate
32: Stripe for Transmission Fastening Volt
33: Stripe for Transmission Guiding Plate
35: Deceleration Stripe for Transmission
36: Acceleration Stripe for Transmission
100: Wheelchair Body 110: Caliper Brake
111: Caliper 112: Disc

### MODE FOR THE INVENTION

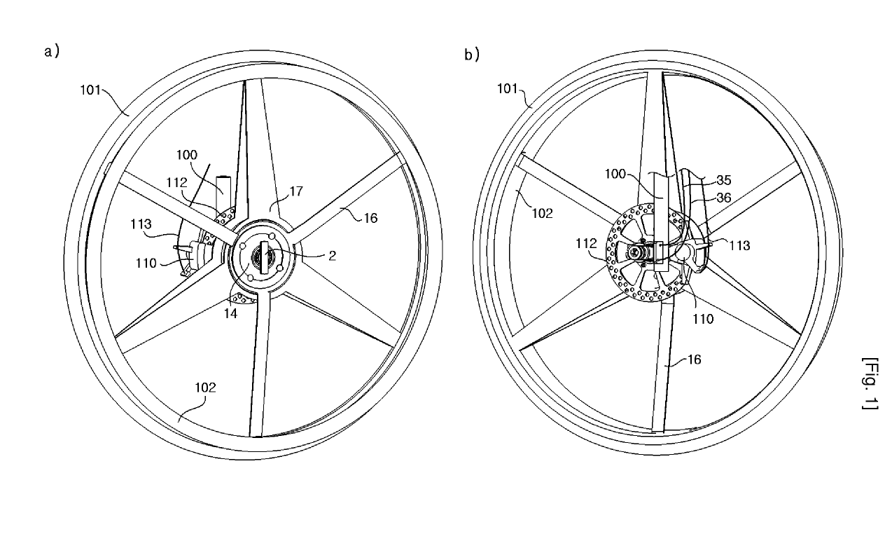

A detailed description of the preferred embodiment for present invention is explained according to the execution drawing as below. The FIG. 1 is a perspective view illustrating a device of this invention mounted on the wheelchair. The FIG. 2 is an exploded perspective view of parts of 3-speed planetary gear type transmission of FIG. 1.

The planetary gear type transmission is consisted of two planetary gear rows by present invention. The planetary gear row is working when the sun gear is worked as a constant element, if the inscribing gear is an input side, then the carrier works as an output side and decelerates, in this case let's call the inscribing gear as a deceleration inscribing gear. On the contrary if the carrier works as an input side, then the inscribing gear works as an output side and accelerates, in this case let's call the inscribing gear as a acceleration inscribing gear. The acceleration solar gear, the acceleration planetary gear and the acceleration inscribing gear are meshed. The deceleration solar gear, the deceleration planetary gear and the deceleration inscribing gear are meshed. As two planetary gear row are independent to each other, so the module, a transmission ratio and the size of each planetary gear row can be organized differently.

The output carrier (17), playing a role as the center of the wheel of wheelchair, is rotatable with respect to the center shaft (1) and supported by the bearing (17z) and extended to the radial direction with providing one of the side walls for the planetary gear type transmission. The four planetary gear shaft (20) is installed on this side wall to support the four deceleration planetary gear in the deceleration planetary gear row. The output carrier (17) is extended in an axial direction and engaged with the acceleration inscribing gear (12), without contacting to the deceleration inscribing gear (13) which is meshed with the deceleration planetary gear, with surrounding the deceleration inscribing gear (13). The output carrier (17) surrounds the bearing (17z) and protrudes in an axial direction and the outer circumferential surface of the protrusion has a splined shape to engage the disc hub (29).

The input carrier (14) firmly fixed by the volt to the push rim, the input side, is rotatable with respect to the center shaft (1) and supported by the bearing (14z) and extended in the radial direction to provide the other side wall of the planetary gear type transmission. The four planetary gear shaft (19) is installed on this side wall to support the four acceleration planetary gear (10) in the acceleration planetary gear row. Four planetary gear shaft (19) is inserted to the passing through hole (15a) of the input carrier inscribing gear holder (15) which is firmly fixed to the deceleration inscribing gear (12) by the volt or welding so that the deceleration inscribing gear (12) rotates together with the input carrier (14). The push rim (16) fixed with the input carrier (14) stands close to the wheel hub, the output carrier (17), and supports the wheel hub by the sliding bearing and the planetary gear type transmission is blocked out outside environment by the retainer.

The other method is also possible that the input carrier (14) supported by the bearing (14z) protrudes in an axial direction with surrounding the acceleration sun gear (8) and extends in the radial direction between the two planetary gear rows to firmly fix with the deceleration inscribing gear (12). The cap of the output carrier (17) in this case provides the other side wall of the planetary gear type transmission with positioning close to the input carrier (14) and supports the wheel hub by using the bearing so that the retainer blocks the planetary gear type transmission out the outside environment.

The both inner circumferential surfaces of the acceleration sun gear (8) and deceleration sun gear (9) have a step to make larger radius inner circumferential surfaces (8d,9d) and small radius inner circumferential surfaces (8b,9b). The small radius inner circumferential surface surrounds the groove cam rotational direction fixing member (4) and includes many radial direction protrusions (8b) on the surface to mesh with radial direction protrusions (6c) of the first groove cam (6) while the larger radius inner circumferential surfaces (8d,9d) includes a smooth surface. Many shaft direction protrusions (8c,9c) are formed on each side plane of the sun gear (8,9), which is near to the larger radius circumferential surface, to mesh with each other in the centric direction. The two sun gear (8,9), in which centric direction protrusions (8c,9c) are arranged correspondingly, move in the centric direction and are engaged to make a space to house the first groove cam (6) with the help of the two larger radius inner circumferential surfaces (8d,9d) and rotate together. The two sun gear (8,9) possibly have different external diameters depending on the speed change ratio of each sun gear but the other things can be consisted all the same.

The center shaft (1) includes a passing through hole (1a) in an axial direction. One end is consisted of a larger radius and has a step (1b) to contact the inner ring side surface of the bearing (14z) which supports the input carrier (14) while the other end has a small radius to engage with the body of the vehicle. The middle part of the center shaft (1) includes a flat plane (1c) to prevent for the center shaft (1) from rotating and also includes a snap ring groove (1d) to support the inner ring side surface of the bearing (17z) which supports the output carrier (17).

The key groove (1f) to fix the groove cam rotational direction fixing member (4) and the passing through hole (1e) in the radial direction to house the transmission key (5) are formed on the middle part of the larger radius part of the center shaft (1). This passing through hole (1e) is connected to the passing through hole (1a) in a centric direction and the transmission key (5) can be moved around 80 degree to 100 degree range in a rotational direction in this hole (1e).

The small radius part of the center shaft (1) includes 2˜4 passing through holes (1g) in a radial direction to house the balls (26) which make the center shaft (1) fix to the body of the vehicle.

The both end part of the letter “T” shaped transmission shaft (2) are protruded from the passing through hole (1a) of the center shaft (1). The head (2a) of the transmission shaft (2) contacts the terminal part (1b) of the larger radius part of the center shaft (1). Either the key grooves or protrusions are formed on the middle part of the transmittable shaft (2) to house the transmission key (5) and make a firm engagement with the transmission key (5). The other end part of the transmission shaft (2) includes a step to make the balls (26) protruded with supporting the balls, and includes a concave groove (2d) to house the balls when the planetary gear type transmission is separated from the body of the vehicle. This end part includes a groove (2e) to engage with the transmission shaft engaging ring (25) and includes snap ring groove (2f) not to make the transmission shaft engaging ring (25) separate from the bracket.

A spring arranged between the center shaft (1) and the transmission shaft engaging ring (25) pressurizes the balls (26) in both direction to make the balls protruded to the outside from the center shaft (1). At the same time the spring supplies the elasticity in the rotational direction to make the transmission shaft engaging ring (25) engage with the transmission shaft (2) in the rotational direction so that the center shaft (1) is located in the neutral position. This spring always makes the transmission shaft (2) be in the neutral position when the wheel is separated from the body of the vehicle while the spring guides the transmission shaft (2) to make the two sun gears be in a direct connection mode when the wheel is engaged with the body of the vehicle. The external diameter of the transmission shaft engaging ring (25) is formed smaller than the external diameter of the small radius part of the center shaft (1) to make the wheel easily engage and disengage with the body of the vehicle and the transmission shaft engaging ring (25) has grooves on the outer circumferential surface to engage with the transmission stripe holder (30).

The groove cam rotational member (3) which is rotatably supported by the center shaft (1) is installed between the bearing (14z) and the bearing (17z). The key groove (3a) is formed on the inner circumferential surface of the groove cam rotational member (3) to fix firmly with the transmission key (5) while three pairs of the first groove cam (6) and the second groove cam (7) are formed on the outer circumferential surface of the groove cam rotational member (3).

The guiding groove for the first groove cam (6) guides the first groove cam (6) to engage with the acceleration sun gear (8) when the groove cam rotational member (3) rotates in the range of 0 degree˜5 degree (3b) and guides the first groove cam (6) not to engage with two sun gears (8,9) when the groove cam rotational member (3) rotates in the range of 40 degree˜60 degree (3c), and last guides the first groove cam (6) to engage with the deceleration sun gear (9) when the groove cam rotational member (3) rotates in the range of 85 degree˜90 degree (3d) according to present execution example.

The guiding groove for the second groove cam (7) guides the two sun gear (8,9) to engage with each other when the groove cam rotational member (3) rotates in the range of 45 degree˜55 degree (3e). Three pairs of the guiding grooves (3b,3c,3d,3e) are arranged on the groove cam rotational member (3) with having a starting point of 0 degree, 120 degree, 240 degree, respectively, to prevent both the first groove cam (6) and the second groove cam (7) from being shut or leaning to one side so that the first groove cam and the second groove cam works well when both cams (6,7) moves in the centric direction.

The groove cam rotational direction fixing member (4) is immovably installed between the bearing (14z) and the bearing (17z) by the key (21) with respect to the center shaft (1f). Three protrusions are extended parallel in a centric direction from the groove cam rotational direction fixing member (4) and surrounds the groove cam rotational member (3) without contacting the guiding groove (3b,3c,3d,3e) of the groove cam rotational member (3).

The first groove cam (6) includes three concave grooves (6b) to house the balls (6a) which are used to engage with the guiding groove (3b,3c,3d,3e) of the groove cam rotational member (3) and includes three centric direction guiding grooves (6d) to engage with the groove cam rotational direction fixing member (4), respectively, on the inner surface of the first groove cam (6). The radial direction protrusions (6c) are formed on the outer circumferential surface of the first groove cam (6) to engage with the inner circumferential surface radial direction protrusions of sun gears (8,9). Therefore, the first groove cam (6) which is engaged with the groove cam rotational member (3) moves only in the centric direction along the first groove cam guiding groove (3b,3c,3d) even though the groove cam rotational member (3) rotates because the immovable three parallel protrusions extended from the groove cam rotational direction fixing member (4) are already engaged with the three centric direction guiding grooves (6d).

The three concave grooves (7b) which house the three balls (7a) to engage with the guiding groove (3e) of the groove cam rotational member (3) and house three guiding groove (7d) to engage with the groove cam rotational direction fixing member (4) are formed on the inner circumferential surface of the second groove cam (7). The outer circumferential surface of the second groove cam (7) includes a step to house the bearing (9z) which pressurizes the deceleration sun gear (9) in the centric direction. Therefore, the second groove cam (7) which is engaged with the groove cam rotational member (3) by the three balls (7a) moves only in the centric direction along the guiding groove of the second groove cam (6) to press the bearing (9z) and the deceleration sun gear (9) so that both sun gears are engaged with each other even though the groove cam rotational member (3) rotates because the three immovable protrusions extended from the groove cam rotational direction fixing member (4) are already engaged with the three centric direction guiding grooves (7d). The bearing (8z) is arranged between the acceleration sun gear (8) and the input carrier (14) to support in the centric direction the acceleration sun gear (8) so that the acceleration sun gear (8) can not be pushed when both sun gears are engaged with each other.

The wheel center shaft block (27) makes the wheel engage with the body of the vehicle (100). The wheel center shaft block (27) includes a letter “U” type groove (27a) to fix to the round-pole shaped body of the vehicle (100). One can fasten the wheel center shaft block (27) to the body (100) by passing through the round-pole using the volts according to the height of the user. The wheel center shaft block (27) includes the passing through hole (27b) to engage with the center shaft (1) and is extended in axial direction and makes flat planes (27d) to unrotatably support the center shaft (1) of the wheel with flat planes (27d) engaging with the flat planes of the center shaft (1). The middle part of the wheel center shaft block (27) includes the step to house the balls protruded from the center shaft (1) with supporting the center shaft (1). The terminal of the wheel center shaft block (27) includes the extended hole to house the transmission stripe holder (30) and includes a snap ring groove to support inseparably the transmission stripe holder (30). Another step (27e) is formed on the peripheral part of flat planes (27d) to house the concentric disc hub (29) and includes a snap ring groove (27c) to support inseparably the disc hub (29).

The transmission stripe holder (30) is engaged with the transmission handle (drawing not available) installed around the arm rest of the user by connecting two transmission stripes (35,36) and moved when the transmission handle is moved by the user.

Each transmission stripe (35,36) passes through the transmission stripe guiding plate attached to the wheel center shaft block (27) and is wound in an opposite direction, respectively between the outer ring of the transmission stripe holder (30) and the transmission stripe fixing plate (31) and is fixed by the transmission stripe fixing volt (32). The protrusions in the radial direction are formed on the inner circumferential surface of the transmission stripe holder (30) to engage with the transmission shaft engaging ring (25).

The disc hub (29) is connected to the brake system to provide a brake for the vehicle. A smaller radius inner circumferential surface of the disc hub (29) is rotatably supported by the wheel center shaft block (27). A large radius inner circumferential surface of the disc hub (29) has radial direction protrusions to transmit the driving force with engaging with the output carrier (17). The outer circumferential surface of the disc hub (29) has a step to engage with the disc (112) and volt holes are formed in a radial direction on the side plane of the disc hub (29). The disc hub (29) rotates together with the disc (112) because they are fixed by volts. The disc (112) controls the rotation of the wheel, engaging with the caliper (112).

The operation state of the planetary gear type transmission made by the present invention is explained as follows.

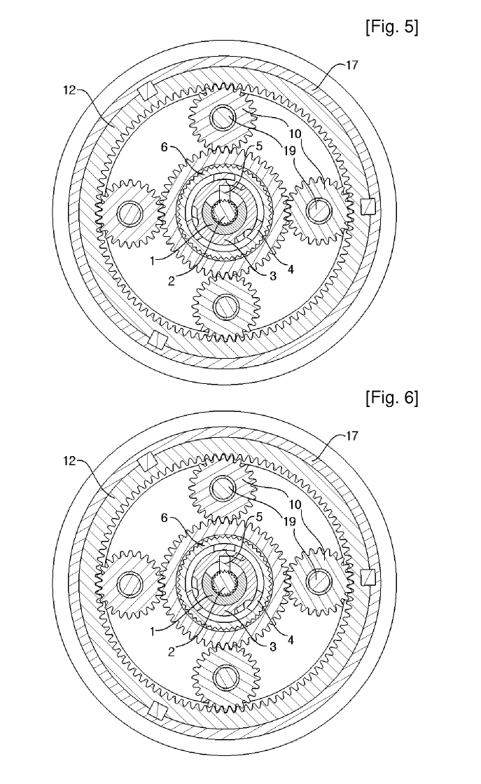

The FIG. 5 is a partial cross sectional view showing the driving state of the 3-speed planetary gear type transmission under the direct connection mode. The FIG. 6 is a cross sectional view taken along the line B-B of the FIG. 5.

The spring (24) guides the transmission shaft engaging ring (25) to the neutral position which makes the transmission shaft (2) be in the direct connection mode when the wheel is engaged with the wheelchair. If one inserts the center shaft (1) to the passing through hole (27b) of the wheel center shaft holder (27) with pulling the head (2a) of the transmission shaft (2) and releases the head (2a), the elasticity of the spring (24) pressurizes the transmission shaft (2) by which the balls (26) are pushed and protruded from the center shaft (1) so that the center shaft (1) is engaged with the wheel center shaft holder (27). The transmission shaft (2) is engaged with the transmission stripe holder (30) by the transmission shaft engaging ring (25).

The second groove cam (7) of the planetary gear type transmission pushes the bearing (9z) and the deceleration sun gear (9) to the acceleration sun gear (8) with the help of the groove cam rotational member (3) and the groove cam rotational direction fixing member (4) to make both sun gears engaged with each other and the guiding groove (3e) of the second groove cam (7) supports two sun gears to maintain the engaged state of two sun gears under the direct connection mode.

As the first groove cam (6) is located in the space (8d,9d) which is provided by the two sun gears when they are integrated without touching two sun gears, so the two sun gear cannot engage with the center shaft (1). This means that the planetary gear rows supported by two bearings (14z,17z) with respect to the center shaft (1) can rotate freely.

Under the direct connection mode, when the driving force is input from the push rim (16) the driving force is transmitted to the 4 acceleration planetary gear shaft (19) through the input carrier (14). This driving force is transmitted to the acceleration inscribing gear (12) and the acceleration sun gear (8) through the acceleration planetary gear (10) and at the same time is transmitted to the deceleration inscribing gear (13) through the input carrier inscribing gear holder (15) which is already engaged with the acceleration planetary gear shaft (19). As the acceleration sun gear (8) and the deceleration sun gear (9) are integrated, so the deceleration sun gear (9) rotates together with the deceleration inscribing gear (13). Therefore the planetary gear type transmission of present invention makes the direct connection mode. (If any two gear of the planetary gear rotate together, the rest gear rotates the same direction and the same speed, which equals the direct connection state.)

The wheel (17) and the push rim (16) are rotatbly supported by the center shaft (1). As the input carrier (16) is linked in the direct connection mode to the output carrier (17), the rotational speed of the push rim (16) equals the rotational speed of the wheel (17).

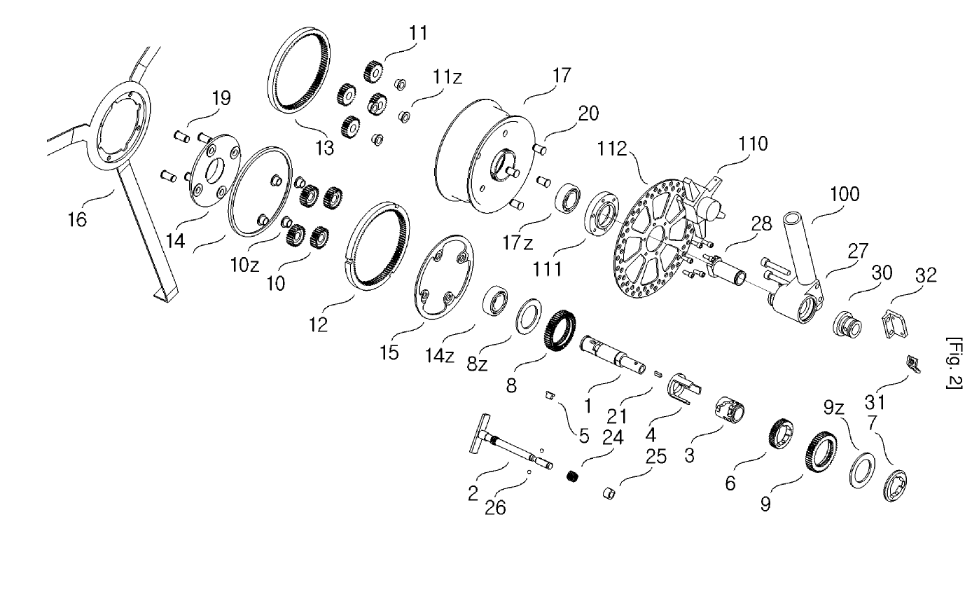

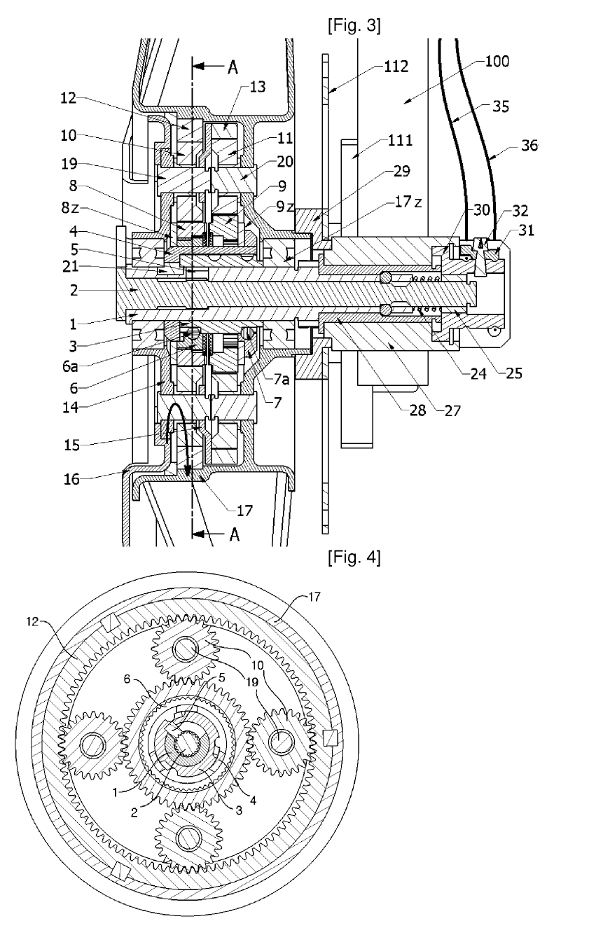

The FIG. 3 is a partial cross sectional view showing the driving state of the 3-speed planetary gear type transmission under the acceleration connection mode. The FIG. 4 is a cross sectional view taken along the line A-A of the FIG. 3.

If one chooses the acceleration mode by moving the transmission handle, the transmission stripe holder (30) rotates anticlockwise which is installed on the wheel center shaft holder (27) because the acceleration transmission stripe (36) is pulled and the deceleration transmission stripe (35) is loosened. The transmission key (5) rotates anticlockwise as shown FIG. 4 because the transmission stripe holder (30) is engaged with the integrated transmission shaft engaging ring (25)/transmission shaft (2)/transmission key (5).

If the transmission key (5) rotates, the groove cam rotational member (3) rotates together, which makes the guiding groove of the second groove cam (7) rotate. The second groove cam which cannot be rotated by the groove cam rotational direction fixing member (4) releases the pressure in the centric direction which makes both sun gear (8,9) integrated because the second groove cam (7) engaged with the balls (7a) which are located in the guiding groove moves to the output carrier (17) direction along the guiding groove (3f). Both sun gear (8,9) disengaged from the restraint rotate idly in an opposite direction, respectively, which makes two sun gear disengage. (Under this situation there is no fixed element for the torque to be transmitted in the two planetary gear rows. When the user however, is moving the transmission handle, he can not push the push rim simultaneously, that is, there happens no torque input from the push rim.)

Next, the guiding groove of the first groove cam which rotates (3c −>3b) together with the guiding groove of the second groove cam guides the first groove cam (6), which cannot be rotated by the groove cam rotational direction fixing member (4), to the position which makes the first groove cam (6) engage with the inner circumferential protrusions (8b) of the acceleration sun gear (8). As the acceleration sun gear (8) is engaged to the center shaft (1) with the first groove cam (6) engaged with the acceleration sun gear (8), the planetary gear type transmission turns to the acceleration mode.

The transmission is fluently implemented because all the protrusions are engaged in one motion without any frictional noise or any resistance in the wake of engagement even though the acceleration sun gear (8) rotates in low speed. Under the acceleration mode, when the driving force is input from the push rim (16), the driving force is transmitted to the four acceleration planetary gear shaft (19) through the input carrier (14). This driving force is transmitted to the acceleration inscribing gear (12) and the acceleration sun gear (8) through the acceleration planetary gear (10). Although this driving force is transmitted to the deceleration planetary inscribing gear (13), the deceleration planetary gear (11) and the deceleration sun gear (9) through the input carrier inscribing gear holder (15), the deceleration gear row rotates idly due to no fixed element in the deceleration gear row. As only the acceleration gear row works, the driving force is transmitted to the output carrier (17) engaged with the acceleration planetary inscribing gear (12) according to the given ratio of the transmission.

If one chooses the direct connection mode by moving the transmission handle, the transmission stripe holder (30) rotates anticlockwise which is installed on the wheel center shaft holder (27) because the deceleration transmission stripe (35) is pulled and the acceleration transmission stripe (36) is loosened. The transmission key (5) rotates anticlockwise and returns to the direct connection mode as shown FIG. 6 because the transmission stripe holder (30) is engaged with the integrated transmission shaft engaging ring (25)/transmission shaft (2)/transmission key (5).

As the procedure from the acceleration mode to direct connection mode is a reverse procedure from the direct connection mode to the acceleration mode, the detailed explanation is omitted here. The first groove cam (6) disengages the acceleration sun gear (8) and both sun gears are integrated in the centric direction in this transmission procedure.

The transmission is fluently implemented because all the protrusions of the circumferential surfaces are engaged or disengaged in one motion without any frictional noise or any resistance in the wake of engagement and disengagement even though each component rotates at the different and a little bit lower speed, respectively.

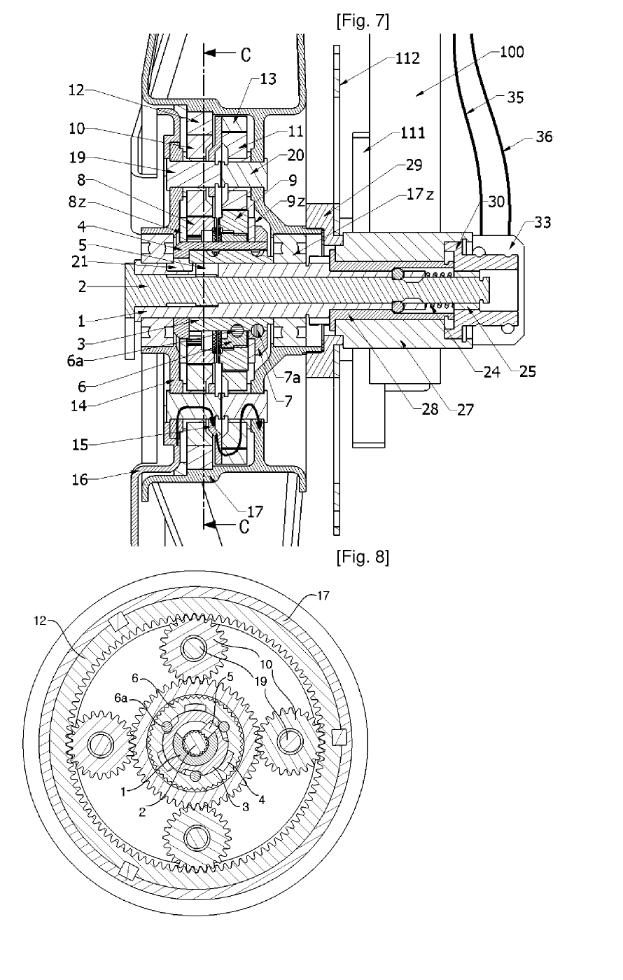

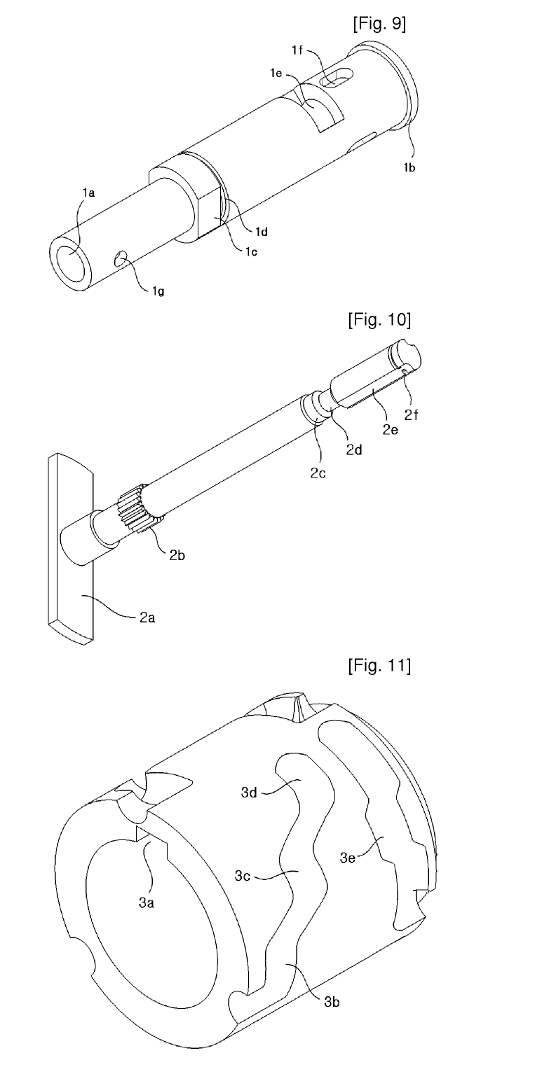

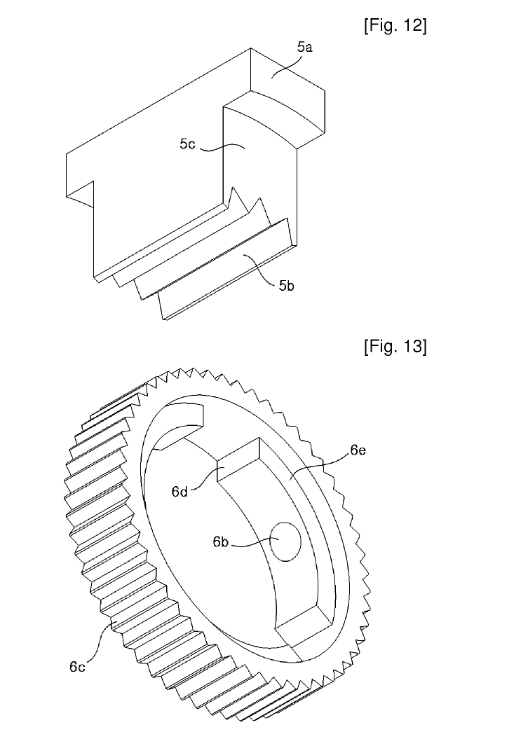

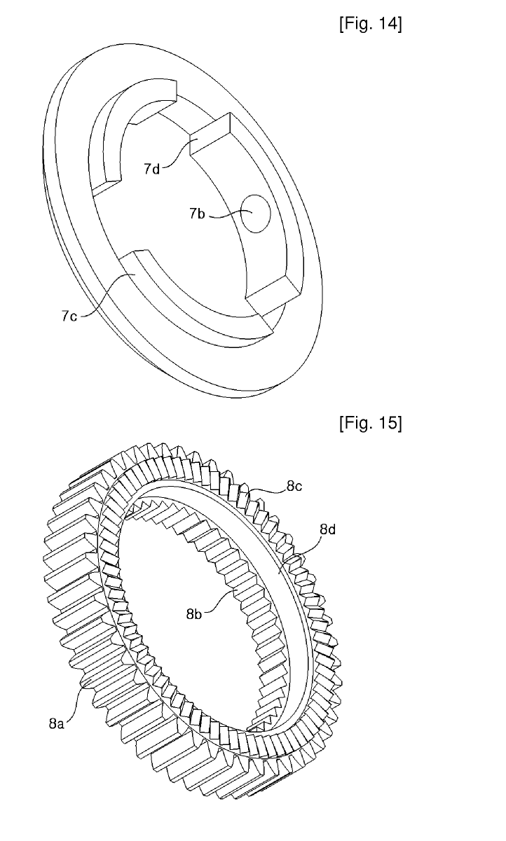

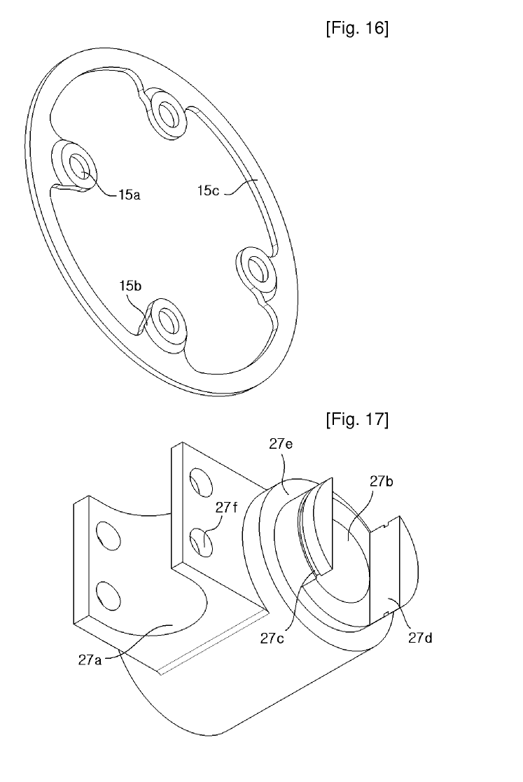

The FIG. 7 is a partial cross sectional view showing the driving state of the 3-speed planetary gear type transmission under the deceleration mode.

The FIG. 8 is a cross sectional view taken along the line C-C of the FIG. 7.

If one chooses the deceleration mode by moving the transmission handle under the direct connection mode, the transmission stripe holder (30) rotates clockwise which is installed on the wheel center shaft holder (27) because the deceleration transmission stripe (35) is pulled and the acceleration transmission stripe (36) is loosened. The transmission key (5) rotates clockwise as shown FIG. 8 because the transmission stripe holder (30) is engaged with the integrated transmission shaft engaging ring (25)/transmission shaft (2)/transmission key (5).

If the transmission key (5) rotates, the groove cam rotational member (3) rotates together, which makes the guiding groove (3e,3f,3g) of the second groove cam rotate. The second groove cam which cannot be rotated by the groove cam rotational direction fixing member (4) releases the pressure in the centric direction which makes both sun gear (8,9) integrated because the second groove cam (7) engaged with the balls (7a) which are located in the guiding groove moves in the output carrier (17) direction along the guiding groove (3e −>3g). Both sun gear (8,9) disengaged from the restraint rotate in an opposite direction, respectively, which causes the state that the torque cannot be transmitted because there is no fixed element in the two planetary gear rows. (Under this situation there is no fixed element for the torque to be transmitted in the two planetary gear rows. When the user however, is moving the transmission handle, he can not push the push rim simultaneously, that is, there happens no torque input from the push rim.)

The guiding groove (3b,3c,3d) of the first groove cam which rotates together with the guiding groove of the second groove cam guides the first groove cam (6), which cannot be rotated by the groove cam rotational direction fixing member (4), to the position which makes the first groove cam (6) engage with the inner circumferential protrusions (9b) of the deceleration sun gear (9). The first groove cam (6) engages with the deceleration solar gear (9) with the deceleration solar gear (9) engaged to the center shaft (1). The transmission is fluently implemented because all the protrusions of the circumferential surfaces are engaged in one motion without any frictional noise or any resistance in the wake of engagement even though the deceleration sun gear (9) rotates.

Under the deceleration mode, when the driving force is input from the push rim (16), the driving force is transmitted to the four acceleration planetary gear shaft (19) through the input carrier (14). Though this driving force is transmitted to the acceleration inscribing gear (12) and the acceleration sun gear (8) through the acceleration planetary gear (10), the acceleration gear row rotates idly due to no fixed element in the acceleration gear row. Thus this driving force is transmitted to the deceleration planetary inscribing gear (13), the deceleration planetary gear (11) and the deceleration sun gear (9) through the input carrier inscribing gear holder (15). As only the deceleration gear row works, the driving force is transmitted in reduced speed to the output carrier (17) engaged with the deceleration planetary gear shaft (20) according to the given ratio of the transmission.

If one chooses the direct connection mode by moving the transmission handle, the transmission stripe holder (30) rotates anticlockwise which is installed on the wheel center shaft holder (27) because the acceleration transmission stripe (36) is pulled and the deceleration transmission stripe (35) is loosened. The transmission key (5) rotates anticlockwise and returns to the direct connection mode as shown FIG. 6 because the transmission stripe holder (30) is engaged with the integrated transmission shaft engaging ring (25)/transmission shaft (2)/transmission key (5).

As the procedure from the deceleration mode to direct connection mode is a reverse procedure from the direct connection mode to the deceleration mode, the detailed explanation is omitted here.

The above desired execution example shows the idea about the structure and the function under the present invention. This example is shown and described for showing one of the possible execution drawings. We can change it in the every possible way under the above mentioned description idea. Present invention includes every possible changeable type in the scope of the attached claims.

### INDUSTRIAL APPLICABILITY

This invention gives the planetary gear type transmission a compact size and a light weight because the carrier plays a role for the housing. The center shaft can be engaged and disengaged with the body of the vehicle. One can choose any mode in an acceleration mode, a deceleration mode and a direct connection mode, without using the clutch and under any mode the planetary gear type transmission transmits the driving force in both ways.

As the planetary gear type transmission includes a carrier which plays dual role for the housing, it is light and compact. The center shaft of it is possibly engaged and disengaged with the vehicle's body. Without using the clutch, one can choose a choice for an acceleration mode, a deceleration mode and a direct connection mode in which the driving force is transmitted with no transmission. The driving force can be transmitted in both ways under any mode.

The present invention is applied to the wheel of the wheelchair. The user can climb the hill or move on the sand or on the carpet at low speed (the deceleration mode ) using lesser strength. The user can move on the flat ground at high speed (the acceleration mode).

1. A planetary gear type transmission characterized in that a pair of single planetary gear rows are combined, and a carrier of one side and a ring gear of the other side are integrated, and a housing of a transmission is formed with the help of said two carriers which operate as an input side and an output side, respectively, and a transmission work is implemented by controlling the each sun gear which is rotatably installed at the fixed center shaft to engage or disengage with said center shaft or by controlling an integration and a disintegration of said two sun gears.

2. The transmission of claim 1, wherein said transmission includes an acceleration mode in which one of said sun gear is engaged to said center shaft not to relatively rotate with respect to said center shaft, a direct connection mode in which said two sun gears are integrated and idly rotate with respect to said center shaft, a deceleration mode in which the other said sun gear is engaged to said center shaft not to relatively rotate with respect to said center shaft, and a stop mode in which two sun gears are integrated and do not relatively rotate with respect to the center shaft.

3. The transmission of claim 2, wherein said transmission includes a groove cam rotational member which is immovable in an axial direction and rotatably supported by said center shaft and a first groove and a second groove are formed on an outer surface of the same; a first groove cam which moves along the first groove of the groove cam rotational member in an axial direction and allows one sun gear either not to relatively rotate or to idly rotate with respect to said center shaft; and a second groove cam which moves along the second groove of the groove cam rotational member in an axial direction and allows said two sun gears either to integrate or to disintegrate with each other, whereby the engagement and the disengagement and an integration and disintegration of two sun gears are controlled depending on a rotational position of the groove cam rotational member for a transmission work.

4. The transmission of claim 3, wherein said sun gear includes protrusions on a part of an inner surface and a side surface of the same and said first and second groove cams are unrotatably supported by said center shaft and outer circumferential surface of said first groove cam includes protrusions to engage with said protrusions of inner circumferential surface of each said sun gear and said first groove moves to the position to engage with one of said sun gear or moves to the position to disengage with both sun gears, and the second groove cam pressurizes in an axial direction and makes said sun gear move to the position in which the side surface protrusions of both sun gears are engaged with each other in case the first groove cam disengages with both sun gears.

5. The transmission of claim 3, wherein said groove cam rotational member is controlled by a transmission shaft which passes through said center shaft in an axial direction.

6. The transmission of claim 5, wherein said transmission shaft passes through said center shaft, and a transmission handle is engaged with the protruded part of said transmission shaft by means of a stripe or a link mechanism or the like, whereby a transmission work is implemented depending on the rotational position of said groove cam rotational member determined by moving said transmission handle.

7. The transmission of claim 6, wherein said transmission handle is engaged with at least two planetary gear type transmissions by means of a stripe or a link mechanism or the like, whereby the transmission work of all the planetary gear type transmission connected with said transmission handle is concurrently implemented.

8. The transmission of claim 7, wherein said transmission handle is engaged with an actuator and includes a sensor for detecting a torque transferred from a driving unit, and includes a controller which judges in accordance with the data from said sensor and controls said actuator so that a transmission work is automatically implemented.

9. The transmission of claim 1, wherein said center shaft is quickly engaged and disengaged with a body of a vehicle and does not rotate with respect to the body of a vehicle when it is engaged.

10. The transmission of claim 1, wherein said transmission is positioned at the center of the wheels of a vehicle with one carrier being engaged with the driving unit, with the other carrier being engaged with the wheels.

11. A vehicle characterized in that a planetary gear type transmission, in which a pair of single planetary gear rows are combined, and a carrier of one side and a ring gear of the other side are integrated, and a housing of a transmission is formed with the help of two carriers which operate as an input side and an output side, respectively, and for thereby implementing a transmission work either by allowing each sun gear rotatably installed at the fixed center shaft to engage or to disengage with the center shaft or by controlling an integration or a disintegration of two sun gears, is installed at the center of wheels, with one carrier being engaged with a driving unit, with the other carrier being engaged with the wheels.

12. The vehicle of claim 11, wherein said wheels including said center shaft are quickly engaged and disengaged with a body of a vehicle.

13. The vehicle of claim 12, wherein a transmission work is controlled by said transmission shaft which passes through said center shaft in an axial direction.

14. The vehicle of claim 13, wherein said transmission shaft of each wheel passes through said center shaft and a transmission handle is engaged with the protruded part of said transmission shaft by means of a stripe or a link mechanism or the like whereby the transmission of at least two vehicle wheels is implemented concurrently by moving one transmission handle.

15. The vehicle either claim 11, wherein said driving unit is a push rim of a wheel chair which is driven by a person.

16. The transmission of claim 2, wherein said center shaft is quickly engaged and disengaged with a body of a vehicle and does not rotate with respect to the body of a vehicle when it is engaged.

17. The transmission of claim 3, wherein said center shaft is quickly engaged and disengaged with a body of a vehicle and does not rotate with respect to the body of a vehicle when it is engaged.

18. The transmission of claim 4, wherein said center shaft is quickly engaged and disengaged with a body of a vehicle and does not rotate with respect to the body of a vehicle when it is engaged.

19. The transmission of claim 5, wherein said center shaft is quickly engaged and disengaged with a body of a vehicle and does not rotate with respect to the body of a vehicle when it is engaged.

20. The transmission of claim 6, wherein said center shaft is quickly engaged and disengaged with a body of a vehicle and does not rotate with respect to the body of a vehicle when it is engaged.

21. The transmission of claim 2, wherein said transmission is positioned at the center of the wheels of a vehicle with one carrier being engaged with the driving unit, with the other carrier being engaged with the wheels.

22. The transmission of claim 3, wherein said transmission is positioned at the center of the wheels of a vehicle with one carrier being engaged with the driving unit, with the other carrier being engaged with the wheels.

23. The transmission of claim 6, wherein said transmission is positioned at the center of the wheels of a vehicle with one carrier being engaged with the driving unit, with the other carrier being engaged with the wheels.

24. The transmission of claim 7, wherein said transmission is positioned at the center of the wheels of a vehicle with one carrier being engaged with the driving unit, with the other carrier being engaged with the wheels.

25. The transmission of claim 8, wherein said transmission is positioned at the center of the wheels of a vehicle with one carrier being engaged with the driving unit, with the other carrier being engaged with the wheels.
